(19) United States
(12) Patent Application Publication
(10) Pub. No.: US 2013/0044851 A1
(43) Pub. Date: Feb. 21, 2013

(54) BACKUP NUCLEAR REACTOR AUXILIARY POWER USING DECAY HEAT

(71) Applicants: James Winters, Latrobe, PA (US); Frank T. Vereb, Coraopolis, PA (US); Jeffrey Dederer, Valencia, PA (US)

(72) Inventors: James Winters, Latrobe, PA (US); Frank T. Vereb, Coraopolis, PA (US); Jeffrey Dederer, Valencia, PA (US)

(73) Assignee: WESTINGHOUSE ELECTRIC COMPANY LLC, Cranberry Township, PA (US)

(21) Appl. No.: 13/211,354

(22) Filed: Aug. 17, 2011

(51) Int. Cl. G21C 9/00

(52) U.S. Cl. 376/299

(57) ABSTRACT

A nuclear plant auxiliary backup power system that uses decay heat following a plant shutdown to produce electrical power through a dedicated steam turbine/generator set. The decay heat produces a hot operating gaseous fluid which is used as a backup to run an appropriately sized turbine that powers an electrical generator. The turbine is configured to utilize a portion of the existing nuclear plant secondary system and exhausts the turbine exhaust to the ambient atmosphere. The system functions to both remove reactor decay heat and provide electrical power for plant systems to enable an orderly shutdown in the event traditional sources of electric power are unavailable.

### BACKGROUND

1. Field

This invention pertains generally to electrical power systems for nuclear powered electrical generating facilities and more particularly to a backup auxiliary electrical power system that employs decay heat as the energy source for generating electrical power.

2. Related Art

The primary side of nuclear reactor power generating systems creates steam for the generation of saleable electricity. For reactor types like pressurized water reactors or liquid metal cooled reactors, the primary side comprises a closed circuit which is isolated and in a heat exchange relationship with a secondary circuit for the production of useful steam. For reactor types like boiling water reactors or gas cooled reactors the gas used for generating saleable electricity is heated directly in the reactor core. A pressurized water reactor application will be described as an exemplary use of the concepts claimed hereafter. The primary side comprises the reactor vessel enclosing a core internal structure that supports a plurality of fuel assemblies containing fissile material, the primary circuit within heat exchange steam generators, the inner volume of a pressurizer, pumps and pipes for circulating pressurized water; the pipes connecting each of the steam generators and pumps to the reactor vessel independently. Each of the parts of the primary side comprising a steam generator, a pump, and a system of pipes, which are connected to the vessel, form a loop of the primary side.

For the purpose of illustration, FIG. 1 shows a simplified pressurized water nuclear reactor primary system, including a generally cylindrical reactor pressure vessel 10 having a closure head 12 enclosing a nuclear core 14. A liquid reactor coolant, such as water, is pumped into the vessel 10 by pump 16 through the core 14 where heat energy is absorbed and is discharged through a heat exchanger 18, typically referred to as a steam generator, in which heat is transferred to a utilization circuit (not shown), such as the steam driven turbine generator. The reactor coolant is then returned to the pump 16, completing the primary loop. Typically, a plurality of the above-described loops are connected to a single reactor vessel 10 by reactor coolant piping 20.

As mentioned in the previous paragraph, the primary fluid having been heated by circulation through the reactor core 14 enters the steam generator 18 through a primary fluid inlet nozzle. From the primary fluid inlet nozzle, the primary fluid is conducted through a primary fluid inlet header, through the interior of a bundle of heat exchange tubes, out a primary fluid outlet header and through a primary fluid outlet nozzle to the remainder of the reactor coolant system. At the same time, feedwater is introduced into the steam generator secondary side, i.e., the side of the steam generator interfacing with the outside of the tube bundle, through a feedwater nozzle which is typically connected to a feedwater ring inside the generator. In one embodiment, upon entering the steam generator, the feedwater mixes with water returning from moisture separators. This mixture, called the downcomer flow, is conducted down an annular chamber adjacent the outside shell of the steam generator until a tube sheet which separates the primary side inlet header from the secondary side of the steam generator, located at a bottom of the annular chamber causes the water to change direction passing in heat transfer relationship with the outside of the heat exchange tubes and up and through the inside of a wrapper which forms the interior wall of the annular chamber. While the water is circulating in heat transfer relationship with the tube bundle, heat is transferred from the primary reactor coolant within the heat exchange tubes to water surrounding the tubes causing a portion of the water surrounding the tubes to be converted to steam. The steam then rises and is conducted through a number of moisture separators that separate entrained water from the steam, and the steam vapor then exits the steam generator through a steam nozzle and is circulated via a steam header to a steam turbine which is connected to drive an electric generator for the production of electricity. The electric generator is connected to transmission and distribution equipment to convey the electric power to the consumer market in a manner well known in the art.

When a nuclear reactor is first shut down, there is a need to remove the residual core decay heat and either maintain a hot standby condition or cool the system down to a cold shutdown condition. The core decay heat is removed from the reactor core by the primary side coolant. This coolant stream passes through a steam generator(s) that exchanges some of the heat energy in the primary coolant to a separate secondary (nonradioactive) stream in the form of steam that is then dissipated. Presently, this energy dissipation occurs by venting of the steam to the atmosphere. The secondary water used to make the steam is continuously provided to the steam generators from an auxiliary source of stored water. Typically, when in this mode, the steam pressure on the secondary side rises to approximately 1,100 psia until the system begins to cool down (requiring stored energy removal in addition to the removal of decay heat). A means for pumping the auxiliary feedwater from the atmospheric pressure to the higher pressure in the steam generator is required for this system to work. Under normal conditions, this power can be provided by either the grid, or in a scenario where the grid is unavailable, by backup diesel generators. Recent events with the earthquake and tsunami in Japan have heightened the awareness of the potential vulnerability of these systems.

Accordingly, another backup power source is desired that can provide defense-in-depth to the grid power and diesel backup generators that are now employed in existing plants as a source of electrical energy for loads such as the feedwater pumps that supply the steam generators used to dissipate decay heat from the reactor, the residual heat removal system used at low primary pressures, and monitoring and control instrumentation for the plant as a whole.

Additionally, such a backup power source is desired that is self-contained within the plant.

### SUMMARY

These and other objects are achieved by a nuclear powered electrical generating facility having a primary and secondary system. The primary system includes a reactor vessel, a steam generator having a primary side connected to the reactor vessel, primary coolant piping connecting the primary side of the steam generator to the reactor vessel and a primary pump for circulating coolant through the primary coolant piping and between and within the reactor vessel and the primary side of a steam generator. The secondary system includes a secondary side of the steam generator in heat exchange relationship with the primary side for generating steam in the secondary side that exits through a steam outlet nozzle, a main steam header connected to the steam outlet nozzle, a main steam turbine/generator connected to the main steam header for receiving steam from the main steam header and converting the steam to electricity. Added to the foregoing conventional design is a small auxiliary backup steam turbine/generator and an extraction conduit connected to the main steam header for connecting the steam generated by the steam generator from decay heat from the reactor to the auxiliary steam turbine/generator. The main steam turbine/generator is configured to produce electricity to satisfy offsite requirements at a normal operating range of parameters generated by a nuclear reaction within the reactor vessel when the nuclear reaction is operating in a power mode. On the other hand, the auxiliary backup steam/turbine is configured to produce electricity to satisfy an onsite requirement from steam generated by the steam generator from decay heat extracted from the nuclear reaction after the nuclear fission reaction within the reactor vessel is in a shut down mode. Preferably, the extraction conduit includes a shutoff valve for closing off the extraction conduit so steam is not diverted from the main steam header into the extraction conduit when the shutoff valve is in a closed position. Preferably, the shutoff valve is designed to fail in an open position and includes an override to open the shutoff valve to test the auxiliary backup steam turbine/generator.

In one embodiment, an electrical output of the auxiliary backup steam turbine/generator is connectable to an auxiliary/startup feed water pump or the plant residual heat removal system and the nuclear powered electrical generating system includes a controller for sensing when there is a loss of power to the residual heat removal system and automatically connects the feedwater or residual heat removal system electrical loads to the auxiliary steam turbine/generator. Preferably, the controller activates the shutoff valve to divert steam to the extraction conduit when a loss of power to the feedwater or residual heat removal system is sensed so that steam is diverted to the auxiliary backup steam turbine/generator.

In this preferred embodiment, the nuclear powered electrical generating facility further includes a feedwater system having a feedwater storage reservoir; and a feedwater pump connected to the feedwater storage reservoir for supplying feedwater to the secondary side of the steam generator in heat exchange relationship with the primary side. The feedwater pump is connectable to an electrical output of the auxiliary backup steam turbine/generator in the event another power source is not available to power the feedwater pump. In existing plants, another power source is typically the electrical grid or an on-site diesel generator. Preferably, the nuclear powered electrical generating facility includes a controller for sensing when there is a loss of power to the feedwater pump and automatically connects the feedwater pump to the auxiliary backup steam turbine/generator in the event another power source is not available.

In its preferred form, the auxiliary backup steam turbine/generator system has a controlled turbine bypass valve and the turbine has a turndown ratio that is consistent with the difference in steam mass flow that is produced at the beginning and end of the decay heat cycle. Preferably, the operation of the system maintains constant load until either a desired time period is reached or load shedding becomes necessary to match the reduction in decay heat power over time.

In this embodiment, the auxiliary steam turbine/generator includes an auxiliary turbine and an auxiliary generator wherein the turbine and generator either are directly or indirectly coupled to one another or are coupled via a speed reducer, such as a gearbox. Preferably, the nuclear powered electrical generating system includes a controller that senses a load on the generator of the auxiliary turbine/generator and controls the power output of the turbine of the auxiliary turbine/generator to match the generator load using a steam dump bypass.

Preferably, the nuclear powered electrical generating system includes a steam drum that is connected to and positioned at an elevation above the steam generator. The exemplary embodiment described herein further includes a containment building for housing the reactor vessel, steam generator, primary coolant piping, primary pump, auxiliary steam turbine/generator, extraction conduit and at least a portion of the main steam and feedwater headers.

### BRIEF DESCRIPTION OF THE DRAWINGS

A further understanding of the invention can be gained from the following description of the preferred embodiments when read in conjunction with the accompanying drawings in which:

FIG. 1 is a simplified schematic of a pressurized water nuclear reactor primary system to which the embodiments described herein can be applied; and

FIG. 2 is a simplified schematic of a nuclear reactor secondary system incorporating the embodiments described herein.

### DESCRIPTION OF THE PREFERRED EMBODIMENT

As stated above, the core decay heat is dissipated by passing the primary coolant through a steam generator that exchanges some of the energy in the primary coolant to a separate secondary stream of water that is converted to steam and subsequently dissipated, typically by venting. The secondary water used to make this steam is continuously provided as feedwater to the steam generators from an auxiliary source of stored water. Typically, when in this mode, the steam pressure on the secondary side rises to approximately 1,100 psia until the system has cooled sufficiently for the pressure to drop. Therefore, a means for pumping the auxiliary feedwater from atmospheric pressure to the higher pressure in the steam generator is required for this system to work. Under normal conditions, this power is provided by either the grid, or in a scenario where the grid is unavailable, by onsite backup diesel generators that are typically maintained outside the containment that houses the reactor's primary system. Recent events with the earthquake and tsunami in Japan have heightened the awareness of the potential vulnerability of these systems. Accordingly, the embodiments described herein provide an alternate and independent means for providing site power for the feedwater or residual heat removal pumps using only the energy that is inherently available in the plant that needs to be dissipated. For small modular reactors, the available decay heat energy is given in the following table. Larger plants like the AP1000, offered by Westinghouse Electric Company LLC, Cranberry, Pa., have correspondingly greater amounts of available thermal energy. The amount of decay heat available from any nuclear reactor is a known function of the reactor's power level just prior to shutdown.

| Time | Avg Power | | Cum. Energy |
|---|---|---|---|
| interval(s) | (MWt) | Energy (MW-hr) | (MW-hr) |
| 0-1 | 173.2 | 0.048 | 0.048 |
| 1-2 | 167.6 | 0.046 | 0.094 |
| 2-4 | 152.9 | 0.085 | 0.179 |
| 4-7 | 133.1 | 0.111 | 0.29 |
| 7-10 | 113.8 | 0.095 | 0.385 |
| 10-20 | 87.5 | 0.243 | 0.628 |
| 20-30 | 60.2 | 0.167 | 0.795 |
| 30-61 | 41.6 | 0.359 | 1.154 |
| 61-200 | 28.05 | 1.083 | 2.237 |
| 200-1000 | 20.35 | 4.522 | 6.759 |
| 1000-3601 | 14.5 | 10.476 | 17.235 |
| 3601-4874 | 11.3 | 3.996 | 21.231 |
| 4874-86401 | 7.75 | 175.509 | 196.74 |
| (1 day) | | | |
| 86401-604801 | 3.8 | 547.2 | 743.94 |
| (1 week) | | | |

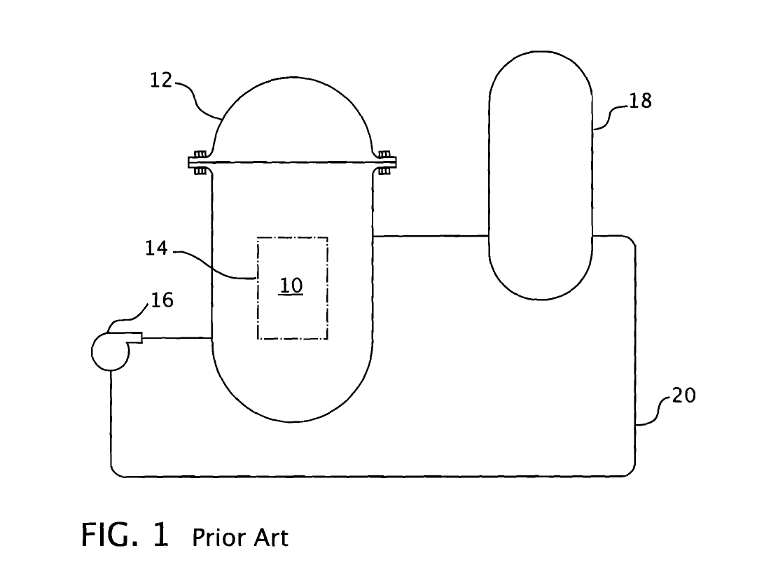

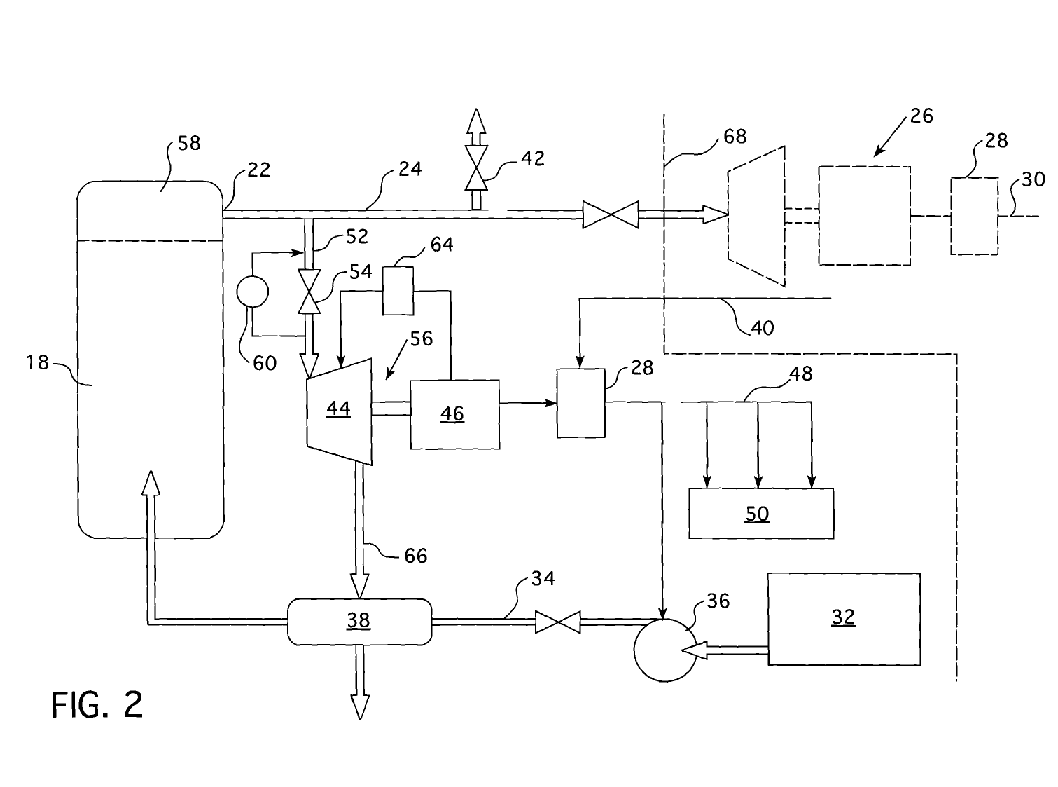

The system described herein can produce enough electrical power to meet a nuclear plant's internal needs, such as feedwater or residual heat removal pumping, as well as other plant loads, like instrumentation and control, experienced during a transient in which power from the electrical grid and the backup diesel generators is unavailable. A system of this type can be invaluable in providing another layer of a “defense in-depth” strategy for protecting a nuclear plant and providing for a controlled shutdown during station blackout. The key components of the system described herein are shown schematically in FIG. 2. FIG. 2 illustrates the steam production (secondary) side of a nuclear power generating facility such as the one shown in FIG. 1. The secondary side of a steam generator 18 has a steam outlet nozzle 22 that is connected to a main steam header 24 which conveys the steam output of the generator to a main turbine/generator 26. The steam drives the generator to produce electricity, which is processed through switchgear 28 which conditions the electricity for transmission over an electrical bus 30 to a consumer destination.

While the plant is operating and during periods in which decay heat is being removed from the reactor vessel 10, feedwater is fed from a feedwater source 32 through a feedwater line 34 to the secondary side of the steam generator 18, powered by a feedwater pump 36. In some instances, a feedwater preheater 38 is employed to reduce the thermal shock imposed by introduction of the feedwater into the secondary side of the steam generator. Under normal operating conditions, power for the feedwater pump is provided by the electrical grid 40, or alternatively, by on-site diesel generators. When the reactor 10 is shutting down, the steam generator is employed to remove the decay heat and the steam thus generated is vented, typically through a main steam dump 42, as it is conventionally known.

In accordance with one embodiment of the invention claimed hereafter, a second, much smaller, auxiliary backup steam turbine/generator system 56 is provided. The turbine 44 of the auxiliary backup turbine/generator system 56 is connected through a suitably sized steam supply or extraction line 52 that is connected through a normally closed isolation valve(s) to the steam generator 18 or steam drum 58 that is connected to the steam generator. During normal plant operation or with power supplied from the auxiliary diesel generators, these valves 54 would be designed to be closed, but fail open so that steam flow to the auxiliary turbine 44 is normally shut off. An override control function or bypass line and valve 60 is provided on these valves to permit periodic testing of the auxiliary backup turbine 44 and its generator 46, as needed. The turbine 44 is designed to operate at the conditions that occur during decay heat removal. This turbine will have a turndown ration (maximum to minimum power ratio) that is consistent with the difference in steam mass flow that is produced at the beginning and end of the decay heat transient. The auxiliary backup turbine/generator 56 employs an electrical generator 46 that is designed to produce alternating current electricity at a specified constant voltage and frequency with varying power over the transient period of interest. A control system 64 that senses generator load and activates a throttle valve for matching the turbine power to plant electrical demand at a constant generator rpm is provided with a steam dump valve used to dissipate steam in excess of that needed for loads supplied by the auxiliary backup turbine/generator. The controller 64 could be a programmable logic controller based system using speed or electrical load sensors and motor actuated valves, or designed to operate as a mechanical governor on the turbine 44. Appropriate electrical switch gear 28 is also provide for interfacing the generator 46 output to the plant electrical distribution network or a subsystem thereof. The electricity thus generated can be connected to power the feedwater pump 36 as well as other plant systems 50 such as the control systems 64 and the residual heat removal pump 16. A heat exchanger 38 can also be installed if needed to preheat the feedwater using the turbine exhaust stream 66 as a heating source. The turbine exhaust may then be vented to the atmosphere. A feedwater preheater might be desirable if the temperature of the feedwater entering the steam generator 18 needs to raised to reduce thermal shock. However, it is desirable to minimize or eliminate the need for this component since it requires higher feedwater pumping power to overcome the pressure drop that would exist across the preheater 38 as compared to a feedwater system without a preheater.

For small modular reactor configurations that are currently being proposed a once through steam generator with a separate steam drum 58 may be used. The steam drum 58 will be sized so that enough water inventory is present to supply the required steam generator feedwater demand for at least the first 80 minutes of decay heat. Because of the high initial decay heat, feedwater flow requirements are highest during this stage of the transient. Auxiliary feedwater would be used after this initial period for long term heat removal. The steam drum 58 is preferably located at an elevation above the steam generator 18 such that natural circulation flow occurs between the steam drum and the steam generator. Under normal operation, this is driven by the hydraulic pressure head difference created by the much higher density of liquid feedwater compared to that of the steam. The feedwater has an even greater density because it is mixed with returned cooler condensate before flowing to the steam generator. In a reactor shutdown situation with steam being vented rather than returned as cooler condensate, the steam drum liquid reservoir temperature will increase to the corresponding saturation temperature for the pressure that the drum operates at. It will be necessary to supplement this hot feedwater supply with additional water to make up for the mass of steam vented to maintain proper pressure in the steam generator and cooling of the primary side. The auxiliary backup steam turbine/generator described herein provides a backup system to the grid and station diesel generators to provide the pumping power to move auxiliary feedwater into the steam drum during decay heat removal transients. The system thus described can provide power and feedwater for as long as there is a supply of stored feedwater and a high enough steam generator pressure.

To best protect the auxiliary power source provided for herein, the auxiliary backup steam turbine/generator 56, extraction conduit 52 and at least a portion of the main steam header 24 may be housed within a seismically qualified building adjacent to the reactor containment schematically represented by dotted line 68. Preferably, the auxiliary/startup feedwater pump 68 is also housed within this building. This building, adjacent to containment, can then best shield this auxiliary backup decay heat removal system from the adverse affects of natural disasters such as a tsunami or tornado.

While specific embodiments of the invention claimed hereafter have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A nuclear powered electrical generating facility comprising:
a reactor vessel having a core housing a nuclear reaction that generates heat;
means for transferring the heat generated in the core to an operating fluid a main header for transporting the heated operating fluid;
a main turbine/generator connected to the main header for receiving the hot operating fluid from the main header and using the heated operating fluid to generate electricity, the main turbine/generator being configured to produce electricity to satisfy off-site requirements at a normal operating range of parameters generated by the nuclear reaction within the reactor vessel when the nuclear reaction is operating in a power mode;
an auxiliary backup turbine/generator connected to the main header and configured to produce electricity to satisfy on-site requirements from the heated operating fluid generated from decay heat extracted from the nuclear reaction when the nuclear reaction within the reactor vessel is in a shutdown mode; and
an extraction conduit connected to the main header for connecting the heated operating fluid generated from the decay heat to the auxiliary backup turbine/generator.

2. The nuclear powered electrical generating facility of claim 1 wherein the extraction conduit includes a shutoff valve for closing off the extraction conduit so the heated operating fluid is not diverted from the main header to the auxiliary backup turbine/generator when the shutoff valve is in a closed position.

3. The nuclear powered electrical generating facility of claim 2 wherein the shutoff valve is designed to fail in an open position.

4. The nuclear powered electrical generating facility of claim 3 including an override to open a path through the extraction conduit to test the auxiliary backup turbine/generator.

5. The nuclear powered electrical generating facility of claim 1 wherein an electrical output of the auxiliary backup turbine/generator is connectable to a plant residual heat removal system, including a controller for sensing when there is a loss of power to the residual heat removal system from traditional sources and automatically connecting the residual heat removal system to the auxiliary backup turbine/generator.

6. The nuclear powered electrical generating facility of claim 5 wherein the extraction conduit includes a shutoff valve for closing off the extraction conduit when the shutoff valve is in a closed position, so the heated operating fluid is not diverted from the main header into the extraction conduit and the controller automatically opens the shutoff valve when a loss of power to the residual heat removal system from traditional sources is sensed so that the heated operating fluid is diverted into the extraction conduit.

7. The nuclear powered electrical generating facility of claim 1 wherein the means for transferring the heat generated in the core to an operating fluid includes a steam generator having a primary and secondary side, and a feedwater system comprising:
a feedwater storage reservoir; and
a auxiliary/startup feedwater pump connected to the feedwater storage reservoir for supplying feedwater to the secondary side of the steam generator, wherein the feedwater pump is connectable to an electrical output of the auxiliary backup turbine/generator in the event the traditional sources are not available to power the auxiliary/startup feedwater pump.

8. The nuclear powered electrical generating facility of claim 7 wherein the traditional sources are an electrical grid and an on-site diesel generator.

9. The nuclear powered electrical generating facility of claim 7 including a controller for sensing when there is a loss of power to the feedwater pump from the traditional sources and automatically connecting the feedwater pump to the auxiliary backup turbine/generator.

10. The nuclear powered electrical generating facility of claim 1 wherein the auxiliary backup turbine/generator has a turndown ratio that is consistent with the difference in steam mass flow that is produced at a beginning and end of a decay heat cycle.

11. The nuclear powered electrical generating facility of claim 10 wherein the auxiliary backup turbine/generator comprises a heated operating fluid dump or bypass valve that dissipates the heated operating fluid in excess of that needed for an auxiliary backup power demand.

12. The nuclear powered electrical generating facility of claim 1 wherein the auxiliary backup turbine/generator comprises an auxiliary turbine and an auxiliary generator wherein a shaft of the auxiliary generator runs at a substantially constant speed.

13. The nuclear powered electrical generating facility of claim 1 including a controller that senses a generator load on a generator of the auxiliary backup turbine/generator and controls a power output of a turbine of the auxiliary backup turbine/generator to match the generator load.

14. The nuclear powered electrical generating facility of claim 1, wherein the means for transferring the heat generated in the core to the operating fluid includes a steam generator and a steam drum positioned at an elevation above the steam generator.

15. The nuclear powered electrical generating facility of claim 1 including a building for housing the auxiliary backup steam turbine/generator, extraction conduit and at least a portion of the main header.

16. The nuclear powered electrical generating facility of claim 15 wherein the means for transferring the heat generated in the core to the operating fluid comprises a steam generator and a feedwater system including a feedwater reservoir and auxiliary/startup feedwater pump, wherein at least the steam generator and feedwater pump are housed within the building.
